(19) United States
(12) Patent Application Publication
(10) Pub. No.: US 2025/0155699 A1
(43) Pub. Date: May 15, 2025

(54) WAVELENGTH TUNABLE LIGHT SOURCE

(71) Applicant: PHOTON ETC. INC., Montréal (CA)

(72) Inventors: Charles-Anthony FORTIN, Montréal (CA); Nicolas DAVID, Montréal (CA)

(21) Appl. No.: 18/837,115

(22) PCT Filed: Feb. 8, 2023
(86) PCT No.: PCT/CA2023/050164

§ 371 Date: Aug. 8, 2024

Related U.S. Application Data
(60) Provisional application No. 63/267,684, filed on Feb. 8, 2022.

(51) Int. Cl. G02B 26/00; G02B 5/18; G02B 27/42

(52) U.S. Cl. CPC G02B 26/007; G02B 5/1866; G02B 27/4244

(57) ABSTRACT

A wavelength tunable light source based on a Volume Bragg Grating (VBG) receives a broadband light beam and outputs a diffracted light beam. The spectral profile of the diffracted light beam includes a selected waveband of the broadband light beam accompanied by out-of-band features spatially dispersed by the VBG. The light source further includes a wavelength tuning mechanism, such as a Theta-2Theta rotation system, comprising a VBG rotation stage operable to rotate the VBG to change the incidence angle by a VBG rotation angle, and a displacement device configured to change a relative alignment between the light input and the light output paths by twice the VBG rotation angle. The light output path has an opening sized to allow at least a portion of the selected waveband through while substantially blocking the out-of-band features.

### TECHNICAL FIELD

The technical field generally relates to light sources generating a light beam at a tunable wavelength and more specifically concerns a wavelength tunable light source based on a Volume Bragg Grating.

### BACKGROUND

Wavelength tunable filters for obtaining a narrowband wavelength out of a broadband light source are widely used for characterisation of different materials or to study optical phenomena. They are generally based on a holographic grating that can be tuned in some way to choose the desired wavelength from the incident light. Such systems have different transmission efficiencies, polarisation characteristics, spectral purity (out-of-band rejection), spectral bandwidth and pointing stability.

There remains a need to provide an improved system that would give access to a large wavelength range and bandwidth, high throughput, high pointing stability and out-of-band rejection.

### SUMMARY

In accordance with one aspect, there is provided a wavelength tunable light source, comprising:
a broadband seed light source generating a broadband light beam;
a light input path receiving the broadband light beam from the broadband seed light source;
a Volume Bragg Grating (VBG) having entrance and exit surfaces, positioned relative to the light input path such that the broadband light beam impinges on the entrance surface at an incidence angle with respect to a normal to said entrance surface, the VBG outputting a diffracted light beam exiting the exit surface at a diffraction angle with respect to a normal to said exit surface, the diffraction angle being equal and opposite to the incidence angle, the diffracted light beam having a spectral profile comprising a selected waveband of the broadband light beam accompanied by out-of-band features spatially dispersed by the VBG;
a light output path;
a wavelength tuning mechanism, comprising:
   a VBG rotation stage operable to rotate the VBG to change the incidence angle by a VBG rotation angle, thereby tuning the selected waveband of the diffracted light beam;
   a displacement device configured to displace at least one of the light input and the light output paths relative to the VBG so as to change a relative alignment therebetween by twice the VBG rotation angle;
   a controller jointly controlling the VBG rotation stage and the displacement device; wherein the light output path comprises an opening sized to allow at least a portion of the selected waveband through while substantially blocking the out-of-band features.

In some embodiments, the broadband seed light source is a supercontinuum source, an arc source, a plasma source, a LED, a LED assembly, a laser excited phosphor or a halogen bulb.

In some embodiments, the VBG comprises a photosensitive material extending between the entrance and exit surfaces and further comprises a three-dimensional recording of Bragg planes in said photosensitive material.

In some embodiments, the VBG has a constant period or a chirped period.

In some embodiments, the VBG has a thickness between about 0.1 mm and about 10 mm, preferably between about 0.7 mm and about 4 mm.

In some embodiments, the VBG is a transmission-type filter.

In some embodiments, the selected waveband of the spectral profile of the VBG has a spectral bandwidth between about 0.1 nm and about 50 nm, preferably between about 1 nm and about 10 nm.

In some embodiments, the out-of-band features comprise at least one of sidelobes, harmonics of a diffracted order and unfiltered white background.

In some embodiments, the VBG is mounted on the VBG rotation stage such that said VBG and said VBG rotation stage have a joint rotation axis extending in parallel to the entrance surface and intersecting the light input path.

In some embodiments, the VBG rotation stage comprises a rotating support and a motor operatively connected to said rotating support. An encoder position unit configured to control the motor of the VBG rotation stage may also be provided.

In some embodiments, the wavelength tuning mechanism comprises a Theta-2-Theta rotation system. The VBG rotation stage is a theta stage of the Theta-2-Theta rotation system, and the displacement device is a 2-theta stage of the Theta-2-Theta rotation system.

In some embodiments, the displacement device comprises a lens configured to collimate the diffracted light beam such that light rays thereof propagate substantially parallel to each other, and the opening is translatable transversally to the collimated beam in conjunction with the rotation of the VBG to align the opening with inner ones of said light rays associated with the selected waveband.

In some embodiments, the wavelength tuning mechanism further comprises a controller jointly controlling the VBG rotation stage and the displacement device.

In some embodiments, the displacement device is configured to displace the light output path relative to the VBG without displacing the light input path.

In some embodiments, the wavelength tunable light source comprises a wall positioned across the light output path, the opening being provided through said wall.

In some embodiments, the opening is an input plane of an optical fiber or an optical fiber bundle.

Other features and advantages will be better understood upon a reading of preferred embodiments thereof with reference to the appended drawings.

### BRIEF DESCRIPTION OF THE DRAWINGS

FIG. 1 is a schematized top view of a tunable wavelength light source according to one embodiment.

FIG. 2 schematically illustrated the interaction of light with a VBG.

FIG. 3A is a graph of the spectral response of a typical diffraction grating; FIG. 3B illustrates the use of the spatial spreading of the wavelengths in a diffracted light beam to filter out undesired spectral features using a spatial filter.

FIGS. 4A and 4B are respectively a schematized top and side view of a Theta-2-Theta rotation system having a theta stage acting as the VBG rotation stage and a 2-theta stage embodying the displacement device.

FIG. 5 schematically illustrates the 2θ change in the relative alignment between the light input and the light output paths when rotating the VBG by a rotation angle θ with respect to the light input path.

FIG. 6 shows a displacement device including a collimating lens according to one variant.

FIG. 7A shows an opening embodied by a slit or hole in a wall positioned across the path of the diffracted light beam; FIG. 7B shows an opening embodied by the input of an output optical fiber or fiber bundle.

FIGS. 8A and 8B are respective perspective view and top view of a tunable light source including an angular compensation scheme and a harmonic filtering scheme.

### DETAILED DESCRIPTION

In accordance with one aspect, there is provided a wavelength tunable light source.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the present description, the term “about” means within an acceptable error range for the particular value as determined by one of ordinary skill in the art, which will depend in part on how the value is measured or determined, i.e., the limitations of the measurement system. It is commonly accepted that a 10% precision measure is acceptable and encompasses the term “about”.

In the present description, when a broad range of numerical values is provided, any possible narrower range within the boundary of the broader range is also contemplated. For example, if a broad range value of from 0 to 1000 is provided, any narrower range between 0 and 1000 is also contemplated. If a broad range value of from 0 to 1 is mentioned, any narrower range between 0 and 1, i.e. with decimal value, is also contemplated.

It is to be understood that the phraseology and terminology employed in the present description is not to be construed as limiting and are for descriptive purposes only.

Furthermore, it is to be understood that the technology can be carried out or practiced in various ways and that it can be implemented in embodiments other than the ones outlined described herein.

Meanings of technical and scientific terms used herein are to be commonly understood as by one of ordinary skill in the art to which the present disclosure belongs, unless otherwise defined.

Wavelength tunable light sources such as described herein may be of use in a variety of applications, such as for example hyperspectral imaging by reflectance on the human retina, or high precision spectral characterisation of optical elements or material.

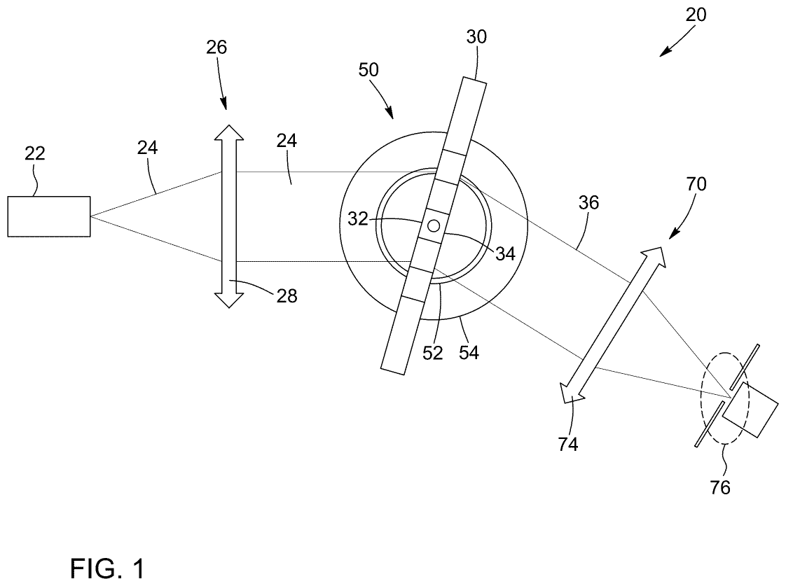

Referring to FIG. 1, a wavelength tunable light source 20 according to one embodiment is schematically illustrated.

The wavelength tunable light source 20 may first include a broadband seed light source 22. The broadband seed light source 22 generates a broadband light beam 24. The expression “light” as used herein is not meant to be limited to electromagnetic radiation in the visible spectrum and may for example include wavelengths in the UV, NIR or IR domains. One skilled in the art will readily understand that the expression “broadband” is used in the context of the present description to refer to light having spectral contents over a range broad enough to cover the intended wavelength tuning range of the wavelength tunable light source. By way of example, eye retina analysis typically uses wavelengths in the approximate 450-900 nm range, wavelengths between about 400-1000 nm are typically used for application using silicone detector, and the infrared characterisation materials use wavelengths in the approximate 1000-1700 nm range. In some implementations, the broadband seed light source 22 may for example be embodied by a supercontinuum source, an arc or plasma source, a LED or LED assembly, a laser excited phosphor, a halogen bulb, or any other source apt to generate light having spectral contains covering the range desired for a given application.

The wavelength tunable light source 20 may further include a light input path 26 receiving the broadband light beam 24 from the broadband seed light source 22, a volume Bragg grating (VBG) 30, and a light output path 70. The light input path 26 may be defined by any components or assembly of components allowing the broadband light beam 24 to travel from the broadband light source 22 to the VBG 30. One skilled in the art will readily understand that the light input path 26 may include one of more lenses, mirrors, slits, waveguides or any other suitable type of optical or optomechanical components affecting the propagation and/or properties of the broadband light beam 24. By way of example, in FIG. 1 the input light path 26 includes a collimating lens 28 disposed between the broadband light source 22 and the VBG 30.

The VBG 30 may be understood as a holographic diffraction grating for which there is a periodic modulation of the refractive index through the entire volume of a photosensitive material, between parallel surfaces defining an entrance surface 32 and an exit surface 34. The VBG may be embodied by a three-dimensional (3-D) recording of Bragg planes in the photosensitive material operating according to the Bragg interference principle. In some implementations, the 3-D nature of a volume hologram offers high diffraction efficiency (close to 100%), high wavelength selectivity and the ability to multiplex multiple holograms (e.g., multiple Bragg gratings) in the same volume.

In some implementations, the photosensitive material of the VBG 30 may be doped glass such as photo-thermo-refractive (PTR) glass or an other transparent material of equivalent properties, such as fused silica, in which the refractive index modulation can be induced in some way, for example by ultrafast\femtosecond laser inscription or the like. It will be readily understood that the choice of material may differ depending on the requirements of a particular application.

In some implementations, the VBG may have a constant period, while in other variants a chirped VBG may also be used. The thickness of the VBG may for example by in a range between about 0.1 mm and 10 mm, and preferably between about 0.7 mm and 4 mm.

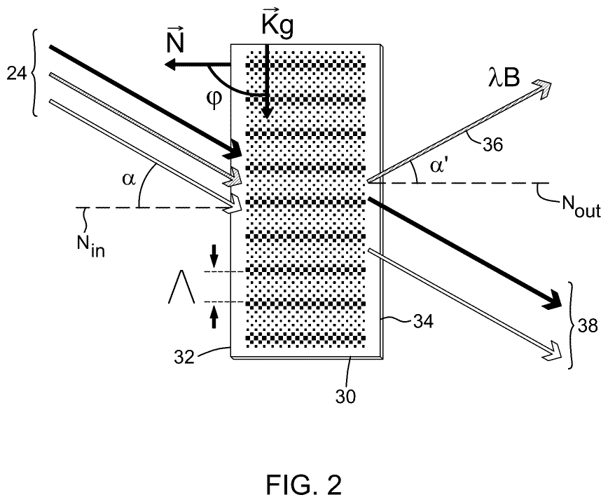

The VBG 30 is preferably embodied by a transmission-type filter. Referring to FIG. 2, in some implementations the VBG 30 is positioned relative to the light input path 26 such that the broadband light beam 24 impinges on the entrance surface 32 at an incidence angle α with respect to a normal Nin to this entrance surface 32. According to the operation principle of the VBG 30, the spectral components of the broadband light beam 24 which meet a diffraction condition of the grating form a diffracted light beam 36 exiting the exit surface 34 at a diffraction angle α with respect to a normal Nout to the exit surface 34. The diffraction angle α is equal and opposite to the incidence angle α (for parallel entrance and exit surfaces 32 and 34). The operation principle of this type of grating is based on the well-known Bragg's Law, according to which the selected Bragg wavelength λB meeting the diffraction condition is determined from:

$${λ}_{B} = 2 Λ n sin α \qquad ( 1 )$$

where n is the refractive index of the VBG and Λ is the period of the index modulation of the VBG. It can therefore be understood that the selected wavelength will depend both on the spectral filtering characteristics of the VBG, determined by intrinsic factors such as n and Λ, and by the incidence angle α of the broadband light beam 24. Only the spectral component which is in alignment with the Bragg condition is diffracted and outputted from the VBG at the diffraction angle α′, the light rays of the remainder of the broadband light beam 38 passing through the VBG 30 undiffracted, and therefore undeflected from their original propagation direction.

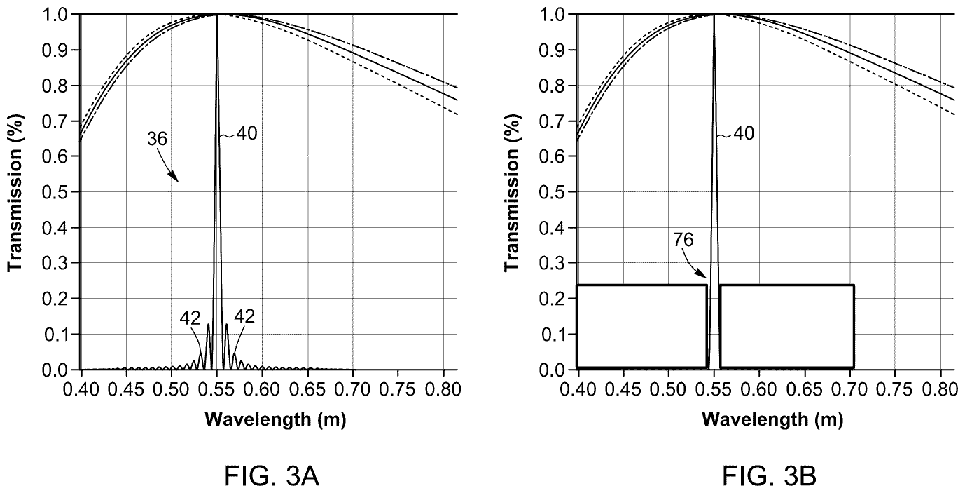

Referring to FIG. 3A, as well know to those skilled in the art, real-life diffraction gratings have a spectral response which is not purely monochromatic. On the one hand, the diffracted light beam 36 includes a narrow waveband around the Bragg wavelength, embodying a selected waveband 40 of the VBG. The spectral bandwidth of the selected waveband 40 is typically between about 1 and 10 nm but can be as small as about 0.1 nm or as high as about 50 nm in some cases. On the other hand, artefacts of the diffraction process also lead to out-of-band features 42, for example sidelobes, harmonics of the principal diffracted order or unfiltered white background, on one or both sides of the peak embodying the selected waveband 40.

Referring back to FIG. 2, the VBG 30 may be fully described by the following parameters: the thickness of the grating between the entrance surface 32 and the exit surface 34, the refractive index (n0) of the photosensitive material, the period (Λ) of the grating (or spatial frequency f=1/Λ), the incidence angle (α) between the incident beam and the normal to the entrance surface (Nin), and the inclination of the Bragg planes (φ defined as the angle between the normal to the entrance surface (Nin) and the grating vector (Kg).

Referring back to FIG. 1, the wavelength tunable light source may further include a wavelength tuning mechanism 50.

The wavelength tuning mechanism may include components providing two independent movements: a VBG rotation stage 52 operable to rotate the VBG 30 to change the incidence angle α by a VBG rotation angle θ, and a displacement device 54 configured to displace at least one of the light input path 26 and the light output path 70 relative to the VBG 30 so as to change the relative alignment between them by 20, that is, twice the VBG rotation angle θ.

As one skilled in the art will readily understand, changing the incidence angle α of the broadband light beam 24 on the entrance surface 32 of the VBG 30 changes the Bragg wavelength diffracted by the VBG 30 according to equation (1) above, and therefore tunes the selected waveband of the diffracted light beam 36 outputted by the exit surface 34 of the VBG 30. In some implementations, the VBG 30 may be mounted on the VBG rotation stage 52 such that the joint rotation axis R of the VBG rotation stage 52 and the VBG 30 extends parallel to the entrance surface 32 and intersects the optical path of the broadband light beam 24. The VBG rotation stage 52 may for example be a rotating support, for example a plate or post, operated by a brushed or brushless motor, controlled or not by an encoder position unit.

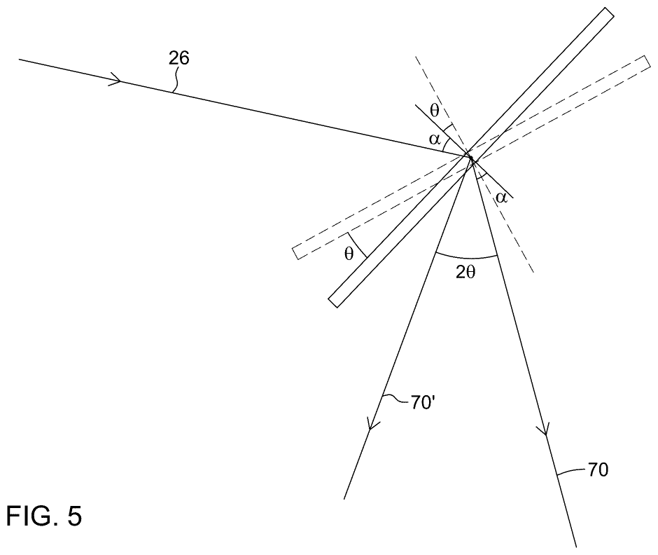

As mentioned above, the displacement device 54 is configured to change the relative alignment between the light input path 26 and the light output path 70 by 20, that is, twice the VBG rotation angle θ. One skilled in the art will readily understand that, by rotating the VBG 30 by a rotation angle θ with respect to the light input path 26, the relative alignment between the light input and the light output paths 26 and 70 will change by an angle 2θ, as both the orientation of the exit surface 34 with respect to the light input path 26 and the diffraction angle (which is equal and opposite to the new value of the incidence angle) will change by a value of θ in the same direction. This is schematically illustrated in FIG. 5. The displacement device 54 therefore ensures that the diffracted light beam 36 remains aligned with the light output path 70 independently of the value of the incidence angle, that is, independently of the selected waveband.

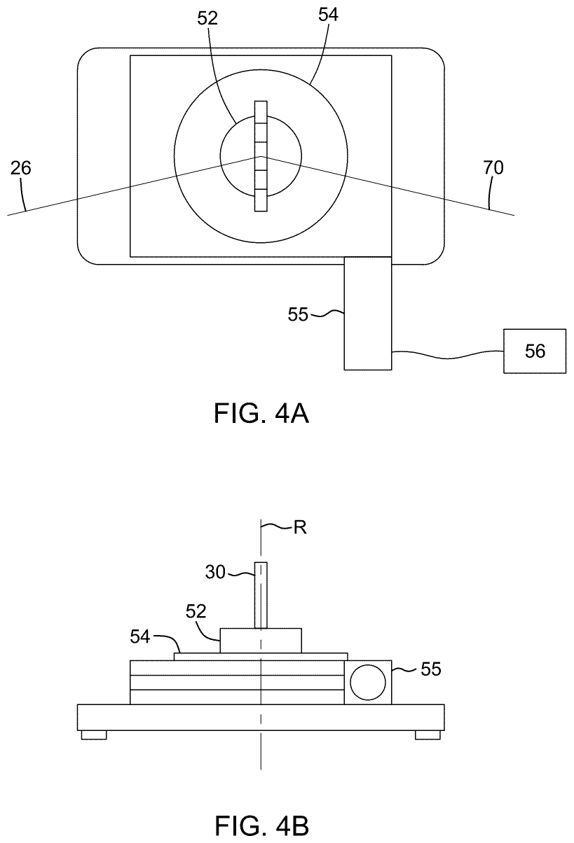

Referring to FIGS. 4A and 4B, in some implementations, the wavelength tuning mechanism 50 may include a Theta-2Theta rotation system 51 having a theta stage acting as the VBG rotation stage 52, and a 2-theta stage embodying the displacement device 54. By way of example, commercially available Theta-2-Theta rotation system typically consists of two rotating platforms or stages arranged in such a way that axes of rotation R of both platforms are aligned. Both stages may be provided with preloaded bearings and may be operated by a common actuator 55, for example a motorized worm gear mechanism for wobble-free rotation and positioning. Hence, both the theta and 2-theta stages are jointly rotatable about a same rotation axis R by respective rotation angles θ and 20. The wavelength tuning mechanism 50 also preferably includes a controller 56 jointly controlling the VBG rotation stage 52 and the displacement device 54. The controller may be embodied by an electronically operated device or combination of such devices, such as processors, circuits, computers, etc., that can provide control signals to the actuator 55, triggering the desired coordinated movement of the VBG rotation stage 52 and displacement device 54.

In the illustrated embodiment, the 2theta rotation of the stage embodying the displacement device 54 is produced by direct drive of the same motor (actuator 55) producing the theta movement of the VBG rotation stage 52. In other variants, two distinct motors or other actuators having a sufficiently high synchronisation and precision may be used to activate the VGB rotation stage 52 and the displacement device 54 independently.

As mentioned above, the VBG 30 is mounted on the VBG rotation stage or theta stage 52. In one variant, the light output path 70 may be displaceable with the displacement device, such as the 2-theta stage of a Theta-2-Theta rotation system. The light output path 70 may include any components or assembly of components allowing the diffracted light beam 36 to travel from VBG 30 to a light output 72 of the wavelength tunable light source 20, for example an output fiber (see FIG. 1) or an output slit. One skilled in the art will readily understand that the light output path 70 may include one of more lenses, mirrors, slits, waveguides or any other suitable type of optical or optomechanical components affecting the propagation and/or properties of the diffracted light beam 36. By way of example, in FIG. 1 the output light path 70 includes a focussing lens 74 disposed between the VBG 30 and the light output 72 and focussing the refracted light beam on the light output 72.

In some implementations, one or more components of the light output 70 path may be displaceable with the 2-theta stage by mounting a plate, breadboard or other rigid structure to the 2-theta stage so as to project radially therefrom.

It will be readily understood that in other variants, it is the light input path 26 that may be displaceable with the displacement device 54 to provide the desired change in the relative alignment between the light input path 26 and the light output path 70.

Referring back to FIG. 3A, as mentioned above, the diffracted light beam 36 includes the selected waveband 40 of the VBG 30, as well as out-of-band features 42 such as for example sidelobes on either side of the peak embodying the selected waveband 40. As the VBG 30, inherently, imparts different diffraction angles to different wavelengths, the spectral spreading of the diffracted light beam 36 directly results in a corresponding spatial spreading of its different wavelength components. In other words, the diffracted light beam 56 exiting the VBG 30 has a spatially spread wavelength distribution transversally to its propagation direction, which includes light at the selected waveband 40 in the center surrounded on either side by the light at the wavelengths of the sidelobes 42.

Referring to FIGS. 1 and 3B, the light output path 70 further include an opening 76 sized to allow at least a portion of the selected waveband 40 through, while substantially blocking the out of band features 42. This configuration therefore makes use of the spatial spreading of the wavelengths in the diffracted light beam 36 to filter out undesired spectral features using a spatial filter. This is schematically illustrated at FIG. 3B. As will be readily understood by one skilled in the art, the position and size of the opening 76 may be selected in view of the beam characteristics of the diffracted light beam 36 so that only the desired portion of the beam, typically in its center, is outputted by the wavelength tunable light source. Advantageously, as the diffracted light beam 36 is maintained in a fixed relative alignment with the light output 72 regardless of the selected waveband 40, the position of the opening 76 can also remain fixed with respect to the light output 72.

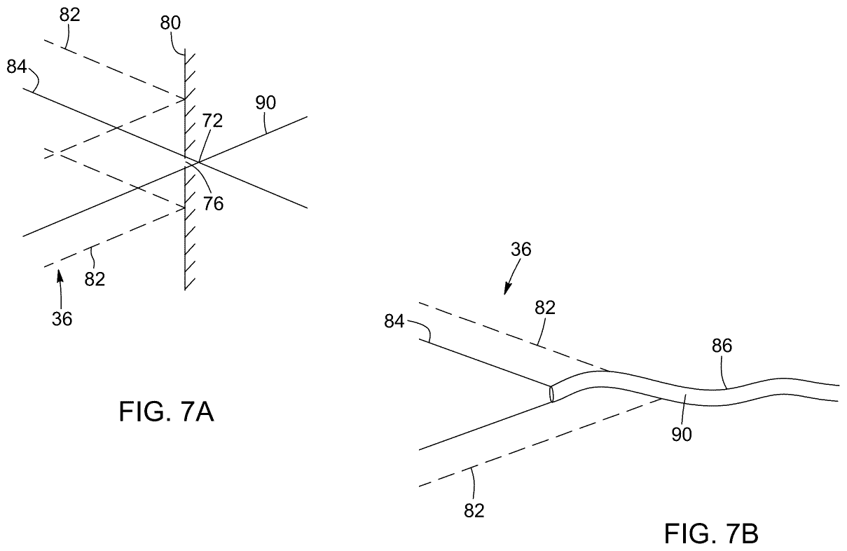

In some implementations, as schematically illustrated in FIG. 7A, the opening 76 may be embodied by a slit or hole in a wall 80 or other opaque structure positioned across the path of the diffracted light beam 86. As can be seen, the outer rays 82 of the diffracted light beam 86 are blocked by the wall 80, absorbed or reflected away, while the inner rays 84 are allow through the opening 76 and therefore constitute the output light beam 90 of the wavelength tunable light source. Referring to FIG. 7B, in other implementations, the opening 76 may be embodied by the input of an output optical fiber 86 or fiber bundle. In this variant, the inner light rays of the diffracted light beam 36 within the acceptance angle of the output optical fiber 86 are collected by the optical fiber and constitute the output light beam 90, whereas the outer rays of the diffracted light beam 86 are uncollected ad continue their travel until absorbed of diffused by other structures. In some variants, an absorber wall or other form of light dump may be provided to prevent stray reflections of the outer rays of the diffracted light beam 36 to have a deleterious impact on the operation of the tunable wavelength light source.

As will be readily understood by one skilled in the art, different optical or optomechanical configurations may be used to embody the components of the wavelength tunable source.

For example, in some implementations the VBG may be off-axis with respect to the rotation axis R, which may for example enable the use of different portions of the VBG in the diffraction process.

In some implementations, for example when coupling the diffracted light beam in a single mode fiber of fiber having a core of a diameter less than 25 μm, it may be advantageously to compensate totally or partially for the chromatic dispersion created by the VBG. This can for example be achieved by adding a prism element before or after the VBG.

Even though the description above uses a Theta-2-Theta rotation system as the wavelength tuning mechanism, in other implementations the wavelength tuning mechanism may be embodied by different mechanical or optomechanical systems or assemblies. By way of example, in some implementations the displacement device may be translational instead of rotational.

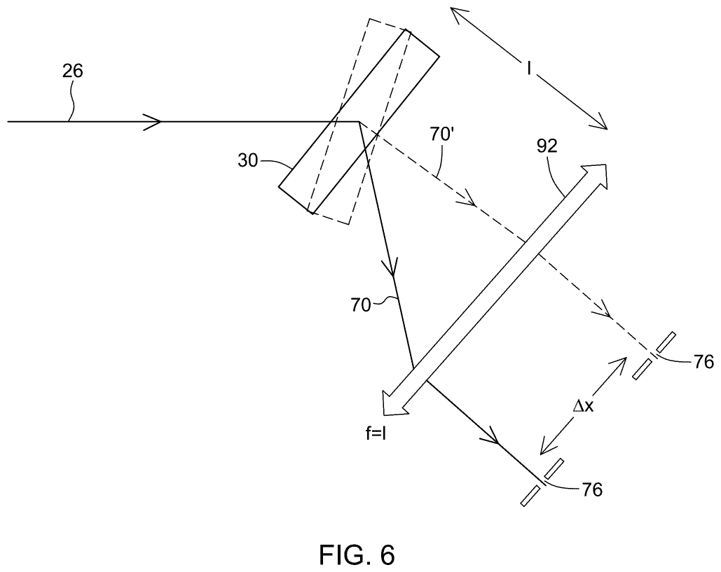

In one variant, as schematically illustrated in FIG. 6, the displacement device may for example include a lens 92 collimating the diffracted light beam such that its light rays propagate substantially parallel to each other, and the opening may be translatable transversally to the collimated beam in conjunction with the rotation of the VBG to align the opening with the inner rays associated with the selected waveband.

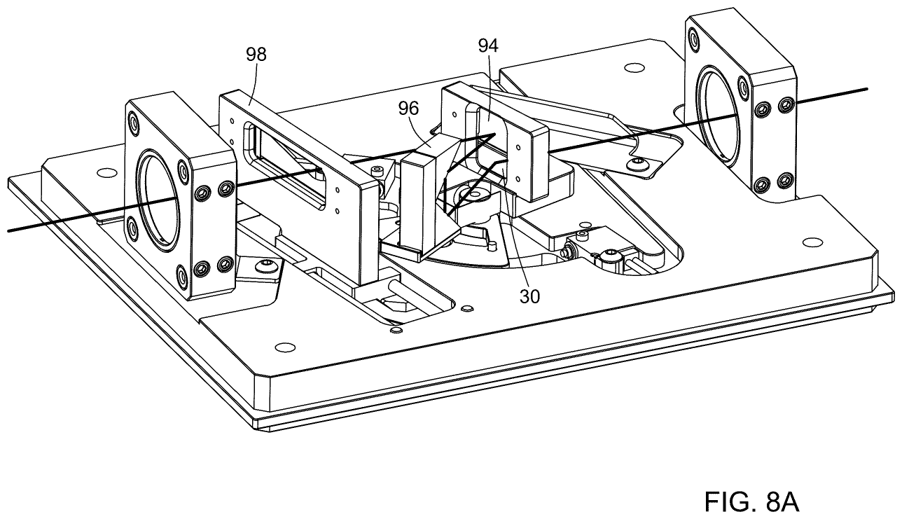

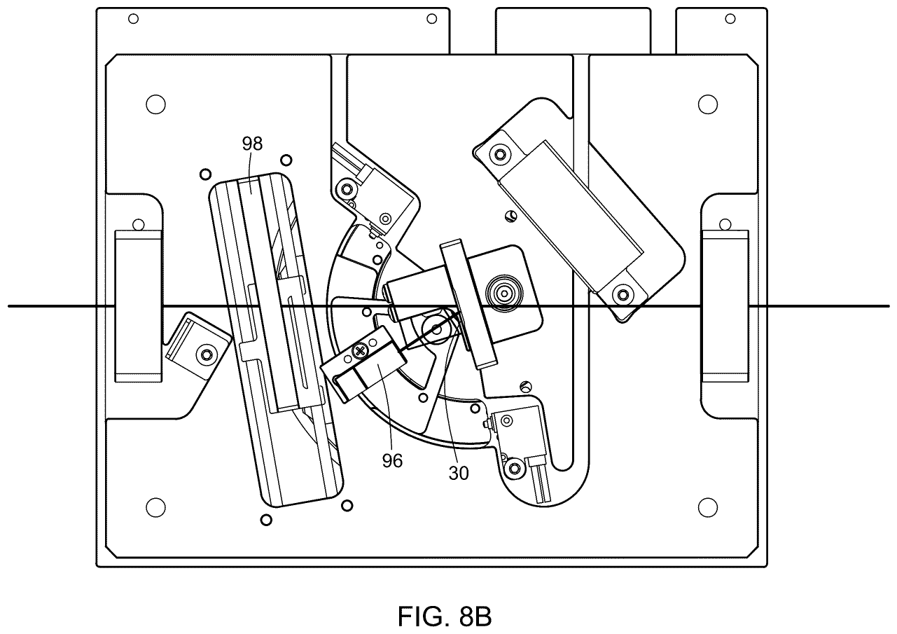

Referring to FIGS. 8A and 8B, there is shown a variant providing a compensation of the angular drift of the diffracted light beam generated by the theta-2theta system, which corresponds to twice the angular adjustment of the VBG filtering optic. By way of example, this compensation can be provided through three reflections. One of these reflections occurs on a central mirror 94 positioned on the same mechanical axis as the VBG 30, either over or under the VBG 30. The other two reflections occur on a mirror assembly 96 in a rooftop configuration placed on the 2Theta portion of the system. It will be noted that the compensation effect can be obtained by providing the three reflections either after the VBG 30 (VBG-Rooftop mirror assembly—central mirror) or after the VBG (central mirror—rooftop mirror assembly—VBG). Advantageously, such an embodiment can produce a stable light beam across the tunable range at the exit of the system.

Still referring to FIGS. 8A and 8B, in some implementations a harmonic filter 98 may be provided in the light input path or the light output path. VBGs typically show leaks of wavelength at a second harmonic at half of the selected wavelength. When the spectral range of the VBG is large enough to create an overlap between the selected wavelength and this second harmonic. In some embodiments, a spectral filter 98, such as a longpass, shortpass or bandpass filter, may be mechanically driven in place by the same motor that performs the VBG angular tuning, in such a way that it is in the output optical path when appropriate and out of the optical path when it is not. By way of example, for a VBG having a spectral range between 400 and 1000 nm, light at wavelengths between 400 to 500 nm should be prevented from reaching the output when wavelengths between 800 nm and 1000 nm are selected. In this example, a long pass filter having a cutoff over 500 nm could be used. This filter is positioned in the output light path when the desired wavelength is in the 800-1000 nm range and removed from the output light path when wavelengths under the cutoff are selected.

Of course, numerous modifications could be made to the embodiments described above without departing from the scope of protection.

1. A wavelength tunable light source, comprising:
a broadband seed light source generating a broadband light beam;
a light input path receiving the broadband light beam from the broadband seed light source;
a Volume Bragg Grating (VBG) having an entrance surface and an exit surface, positioned relative to the light input path such that the broadband light beam impinges on the entrance surface at an incidence angle with respect to a normal to said entrance surface, the VBG outputting a diffracted light beam exiting the exit surface at a diffraction angle with respect to a normal to said exit surface, the diffraction angle being equal and opposite to the incidence angle, the diffracted light beam having a spectral profile comprising a selected waveband of the broadband light beam accompanied by out-of-band features spatially dispersed by the VBG;
a light output path; and
a wavelength tuning mechanism, comprising:
a VBG rotation stage operable to rotate the VBG to change the incidence angle by a VBG rotation angle, thereby tuning the selected waveband of the diffracted light beam;
a displacement device configured to displace at least one of the light input path and the light output path relative to the VBG so as to change a relative alignment therebetween by twice the VBG rotation angle; and
a controller jointly controlling the VBG rotation stage and the displacement device; wherein the light output path comprises an opening sized to allow at least a portion of the selected waveband through while substantially blocking the out-of-band features.

2. The wavelength tunable light source according to claim 1, wherein the broadband seed light source is a supercontinuum source, an arc source, a plasma source, a LED, a LED assembly, a laser excited phosphor or a halogen bulb.

3. The wavelength tunable light source according to claim 1, wherein the VBG comprises a photosensitive material extending between the entrance surface and the exit surface and further comprises a three-dimensional recording of Bragg planes in said photosensitive material.

4. The wavelength tunable light source according to claim 1, wherein the VBG has a constant period.

5. The wavelength tunable light source according to claim 1, wherein the VBG has a chirped period.

6. The wavelength tunable light source according to claim 1, wherein the VBG has a thickness between about 0.1 mm and about 10 mm.

7. The wavelength tunable light source according to claim 1, wherein the VBG has a thickness between about 0.7 mm and about 4 mm.

8. The wavelength tunable light source according to claim 1, wherein the VBG is a transmission-type filter.

9. The wavelength tunable light source according to claim 1, wherein the selected waveband of the spectral profile of the VBG has a spectral bandwidth between about 0.1 nm and about 50 nm.

10. The wavelength tunable light source according to claim 1, wherein the selected waveband of the diffracted light beam has a spectral bandwidth between about 1 nm and about 10 nm.

11. The wavelength tunable light source according to claim 1, wherein the out-of-band features comprise at least one of sidelobes, harmonics of a diffracted order and unfiltered white background.

12. The wavelength tunable light source according to claim 1, wherein the VBG is mounted on the VBG rotation stage such that said VBG and said VBG rotation stage have a joint rotation axis extending in parallel to the entrance surface and intersecting the light input path.

13. The wavelength tunable light source according to claim 1, wherein the VBG rotation stage comprises a rotating support and a motor operatively connected to said rotating support.

14. The wavelength tunable light source according to claim 13, further comprising an encoder position unit configured to control the motor of the VBG rotation stage.

15. The wavelength tunable light source according to claim 1, wherein the wavelength tuning mechanism comprises a Theta-2-Theta rotation system, and wherein:
the VBG rotation stage is a theta stage of the Theta-2-Theta rotation system, and
the displacement device is a 2-theta stage of the Theta-2-Theta rotation system.

16. The wavelength tunable light source according to claim 1, wherein the displacement device comprises a lens configured to collimate the diffracted light beam such that light rays thereof propagate substantially parallel to each other, and the opening is translatable transversally to the collimated beam in conjunction with rotation of the VBG to align the opening with inner ones of said light rays associated with the selected waveband.

17. (canceled)

18. The wavelength tunable light source according to claim 1, wherein the displacement device is configured to displace the light output path relative to the VBG without displacing the light input path.

19. The wavelength tunable light source according to claim 1, comprising a wall positioned across the light output path, the opening being provided through said wall.

20. The wavelength tunable light source according to claim 1, where the opening is an input plane of an optical fiber or an optical fiber bundle.
